(19) United States
(12) Patent Application Publication
(10) Pub. No.: US 2005/0021543 A1
(43) Pub. Date: Jan. 27, 2005

(54) Systems and methods for combining database tables

(76) Inventors: Winfried Schmitt, Walldorf (DE); Helmut Hofmann, Walldorf (DE); Andreas Balzar, Heidelberg (DE)

Correspondence Address: FINNEGAN, HENDERSON, FARABOW, GARRETT & DUNNER;LLP, 1300 I STREET, NW, WASHINGTON, DC, 20005, US

(21) Appl. No.: 10/854,168

(22) Filed: May 27, 2004

(30) Foreign Application Priority Data
May 28, 2003 (EP) 03012031.5

(51) Int. Cl. G06F 7/00

(52) U.S. Cl. 707/100

(57) ABSTRACT

Systems and methods are provided for data processing. Such systems and methods may include providing a set of database tables in a data warehouse, providing a user interface for entering a combination of at least first and second database tables of the set of database tables, storing the combination in a combination database table, and providing an application program for processing the database tables and the combination database table.

### BACKGROUND OF THE INVENTION

1. Field of the Invention

The present invention generally relates to the field of data processing and to systems and methods for combining database tables. More particularly, and without limitation, the invention relates to relational databases and data warehouses.

2. Background Information

Databases are computerized information storage and retrieval systems. A Relational Database Management System (RDBMS) is a database management system (DBMS) which uses relational techniques for storing and retrieving data. Relational databases are organized into tables. A database will typically have many tables that are stored on random access storage devices (RASD), such as magnetic or optical disk drives, for semi-permanent storage.

In recent years, DBMSs have become increasingly popular for several factors, including the decrease in the cost of storage devices and the increased need to store and track electronic information. As DBMSs become increasingly popular, more and more data is stored in databases, and handling, storing, analyzing, archiving, moving, and collating the data becomes more of a concern to those utilizing such data.

To manage this increasing data load various software aids, sometimes referred to as utilities, have been developed. One thing that utilities have in common is that utilities assist users in managing data. They may be simple, such as a back up utility, which merely copies several files. They may be more complex, such as a structured query language interface, which has evolved into a standardized mechanism for manipulating data. They also may be complex and sophisticated on-line analytical processing programs (OLAP) which are designed to do complex analytical processing.

Different types of data, relational and object, are being stored in data warehouses. The term “data warehouse” is used to describe large amounts of related data that are stored together. With the increased data that is stored, there has been an increasing complexity in using, retrieving, sorting and organizing data.

The SAP® Business Information Warehouse is a data warehouse which enables a user to analyze data from operative SAP applications, as well as other business applications and external data sources, such as databases, online services and the Internet.

The administrator workbench functions of the SAP business information warehouse are designed for controlling, monitoring and maintaining all data retrieval processes.

The business explorer of the SAP business information warehouse is a reporting and analysis tool for analysis and decision-making support. The business explorer includes tools for query reporting and online analytical processing (OLAP) functions.

### SUMMARY OF THE INVENTION

Embodiments consistent with the present invention relate to systems and methods for data processing. Such systems and methods may enable a user to enter a combination of at least first and second database tables of a set of database tables stored in a data warehouse. The combination of the first and second database tables may be stored in a combination table for access of or by an application program. In one embodiment, the application program may be adapted to process the database tables of the data warehouse and the combination database table. This has the advantage that a user can conveniently enter information regarding the combination of entries in the database tables of the data warehouse.

In accordance with another embodiment, a user can select the database tables from the set of database tables stored in the data warehouse. This selection can be restricted by the allowable combinations of data types that can be entered into application program as input data. Pairs of entries of the database tables that the user has combined may be stored in the combination database table.

In accordance with yet another embodiment, a matrix may be displayed for determining the entries to be combined. The matrix may have a column direction for displaying the entries of one of the selected database tables and a row direction for displaying of the entries of the other one of the selected database tables. For each matrix element, a check-box is displayed. By clicking on a check-box, the user can combine the corresponding column and row entries.

According to another embodiment, the entries of the selected database tables are displayed in separate lists which are distanced by a connector field. A combination of list entries may be entered by connecting the entries to be combined by, for example, a graphical connector symbol.

In accordance with still another embodiment, the connectors which have been entered for a given entry in one of the lists may be visualized in response to a user's selection of the entry.

According to embodiment, a user can enter rules for the combination of entries in different database tables. For example, these rules can reflect a business structure of the enterprise, as far as the assignment of companies and legal entities of the company to profit centres or business units is concerned.

In accordance with another embodiment, the user may select a number n of database tables from the data warehouse to be combined. In order to enter the combination, the user specifies m-tuples of entries, where each one of the m-tuples contains one entry from each one of the selected database tables. The m-tuples that are created this way may be stored in the combination database table.

The various embodiments can include and/or exclude different aspects, features and/or advantages, where applicable. In addition, various embodiments can combine one or more aspects or features of other embodiments, where applicable.

It is to be understood that both the foregoing general description and the following detailed description are exemplary and explanatory only and are not restrictive of the invention, as claimed.

### BRIEF DESCRIPTION OF THE DRAWINGS

The preferred embodiments will be explained in greater detail by making reference to the drawings, in which:

FIG. 1 is a block diagram of an embodiment of a data processing system consistent with the invention;

FIG. 2 shows an example of a user defined combination database table;

FIG. 3 is illustrative of an embodiment of a data processing method consistent with the invention;

FIG. 4 shows an embodiment of a user interface for entering combinations of data table entries; and

FIG. 5 illustrates another embodiment for a user interface for entering of combinations.

### DESCRIPTION OF THE EMBODIMENTS

The following detailed description of embodiments of the present invention refers to the accompanying drawings. Where appropriate, the same reference numbers in different drawings refer to the same or similar elements.

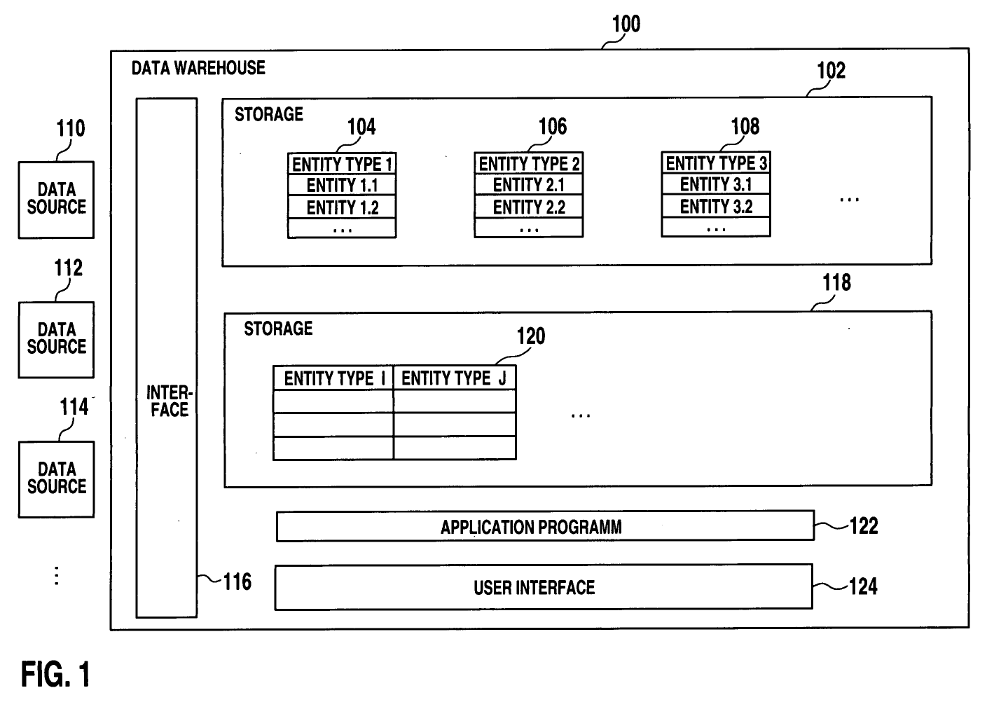

FIG. 1 shows an exemplary data warehouse computer system 100, consistent with an embodiment of the invention. In the example of FIG. 1, data warehouse computer system 100 includes a storage 102 for storing a number of database tables 104,106, and 108.

Data from internal or external data sources 110,112,114, etc. is extracted, transformed and/or loaded into data warehouse computer system 100 via interface 116. The imported data is stored in the database tables 104,106,108, etc., where each database table stores data of the same entity type. A data item of a certain entity type, which is stored in one of the database tables 104,106, and 108, is referred to as “entity” herein

In the example considered, database table 104 stores entities of entity type 1. For example, entity type 1 may be “account numbers of customers”. In this instance, entity 1.1 is the account number of customer A, entity 1.2 is the account number of customer B, etc.

Database table 106 stores data entities that have entity type 2. For example, entity type 2 may be “account numbers of vendors”. In this instance, entity 2.1 is the account number of vendor A, entity 2.2 is the account number of vendor B, etc.

Further, in the example of FIG. 1, database table 108 may have entity type 3 “legal entity” and may store the legal entities of a company. In this instance, entity 3.1 is “xy GmbH”, entity 3.2 is “xy Ltd”, etc.

Data warehouse computer system 100 may also include a storage 118 for storage of one or more combination database tables 120, etc. Each combination database table 120 may have a left column for storing entities of entity type i and a right column for storing of entities of entity type j.

As shown in FIG. 1, data warehouse computer system 100 also comprises an application program 122 for performing a certain type of business oriented data processing, such as for the purposes of accounting, book keeping and/or consolidation. The application program 122 is designed to process certain classes of database tables and combination database tables. For example, application program 122 may be designed to process database tables containing account numbers and organizational entities, and combination database tables combining legal entities and profit centers.

By means of user interface 124, a user may select first and second database tables of storage 102 as a basis to create combination database table 120. For example, the user may select database table 106 having entity type i=2 and database table 108 having entity type j=3. Now the user may enter combinations of the entities stored in the database tables 106 and 108. In order to create pairs of entities having entity types i=2 and j=3, the user may select one of the entities of entity type 2 of database table 106 and assign this entity to one of the entities of entity type j=3 of database table 108. This pair of entities may be entered into combination database table 120, whereby the entity having entity type i=2 is entered in the left column and the other entity having the entity type j=3 is entered in the same row in the right column. This procedure may be performed for all entities of the database tables 106 and 108 that need to be combined.

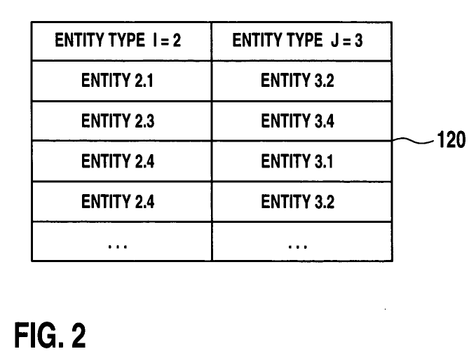

For purposes of illustration, FIG. 2 shows an example of user entries into combination database table 120.

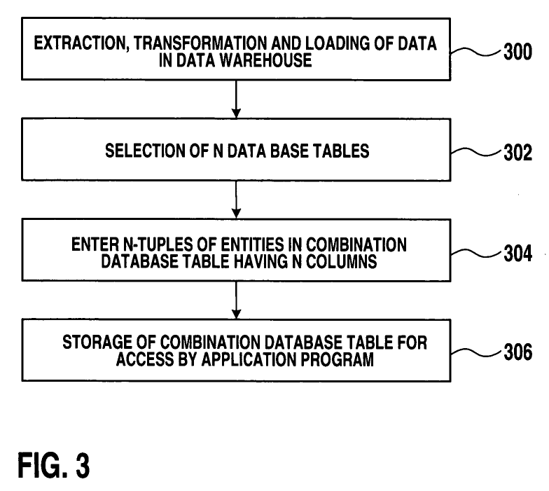

Referring now to FIG. 3, a flow chart of an exemplary method is provided, consistent with an embodiment of the invention. The exemplary method of FIG. 3 may be used in combination with data warehouse computer systems, such as that presented in FIG. 1.

In stage 300, data for entity types may be extracted, transformed and loaded from internal or external data sources. In stage 302, a user selects a number (n) of database tables of the data warehouse computer system. In stage 304, the user specifies a number of n-tuples of entities for storage in the combination database table. In stage 306, the resulting combination database table is stored for access by application program 122.

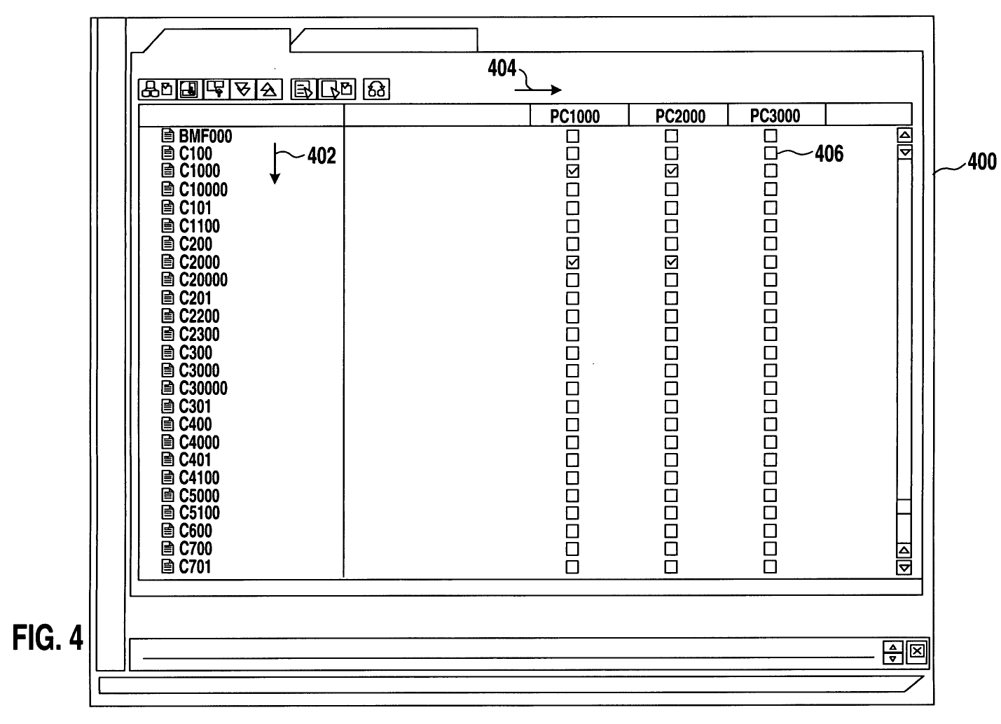

Consistent with the invention, FIG. 4 illustrates an exemplary embodiment of user interface 124 (cf. FIG. 1). By means of user interface 124, a dialogue box 400 is created. Previously, the user has selected a database table storing legal entities and a database table storing profit centres. The legal entities may be displayed in column direction 402 of dialogue box 400, i.e., legal entities BMF000, C100, C1000, C10000, C101, etc.

The profit centers of the other one of the user selected database tables may be displayed in row direction 404 within dialogue box 400. This way a matrix may be defined, where each matrix element has a coordinate within dialogue box 400 that is determined by a pair of legal entities and profit centers. On each matrix element, a check-box 406 may be displayed.

In the example considered here, the user has checked the check-boxes at matrix elements: C1000, PC1000; C1000, PC2000; C2000, PC1000; and C2000, PC2000. This way the user has specified corresponding combinations of entities of the database tables that are stored in the combination database table.

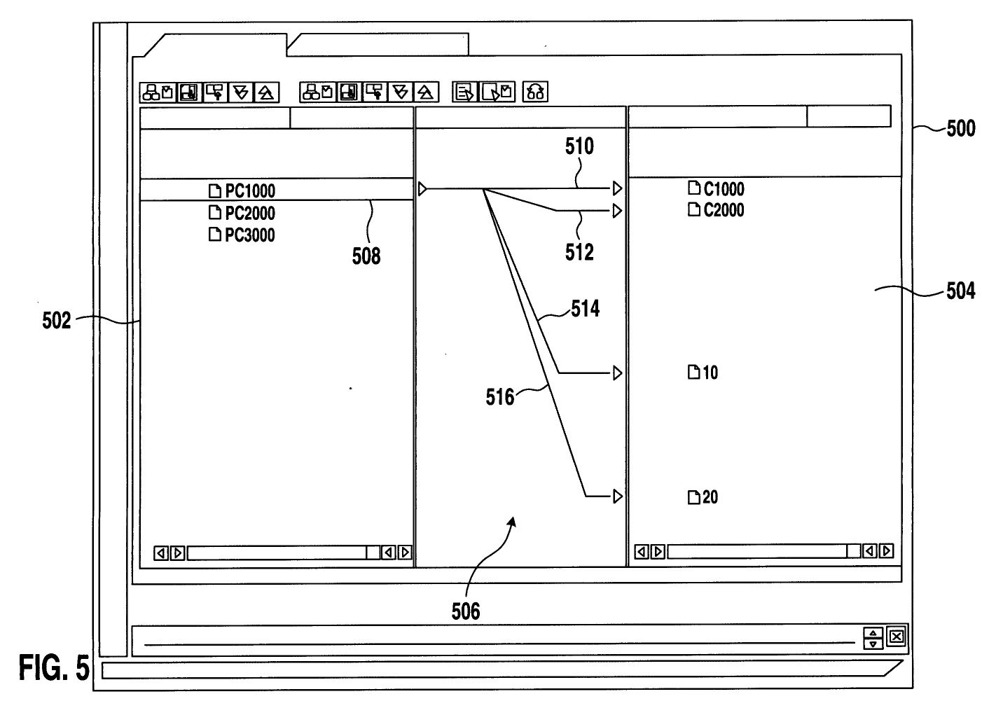

FIG. 5 shows another exemplary embodiment of user interface 124 (cf. FIG. 1). In this example, dialogue box 500 shows list 502 of entities of one of the selected database tables, i.e., the database table storing the profit centers. Further, dialogue box 500 has list 504 showing the entities of the other one of the selected database tables, i.e., the legal entities of the company.

The lists 502 and 504 may be separated by a connector field 506. In connector field 506, a user may enter connectors from an entity of list 502 to entities of list 504 and from entities of list 504 to entities of list 502. When a user moves selection bar 508 onto one of the entities of list 502 or list 504, the connectors originating from the selected entity may be shown in connector filed 506.

For example, as illustrated in the embodiment of FIG. 5, the user has moved the selection bar 508 onto profit center entity “PC1000” in list 502. In response, connectors 510, 512 and 514 are shown in connector field 506.

In addition, the user may enter an additional combination between PC 000 and legal entity 20 by entering connector 516. This may be done by drawing a corresponding connection by means of, for example, a computer mouse, a pointer, etc. The user may then move selection bar 508 to another entity of list 502 or 504 for visualization of previously entered combinations and/or for entering or editing combinations. These combinations may be stored in the corresponding combination database table (cf. combination database table 120 of FIG. 1).

Consistent with one embodiment, more than two lists may be shown in dialogue box 500 on both sides of the connector field. Selection bar 508 may be used to select any one of the entities of the lists for display of the connectors originating for the selected entity.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the invention. For example, the described implementations include software, but systems and methods consistent with the present invention may be implemented as a combination of hardware and software or in hardware alone. Additionally, although aspects of the invention are described for being stored in memory, one skilled in the art will appreciate that these aspects can also be stored on other types of computer-readable media, such as secondary storage devices, for example, hard disks, floppy disks, or CD-ROM, the Internet or other propagation medium, or other forms of RAM or ROM.

Computer programs based on the written description and flow charts of this invention are within the skill of an experienced developer. The various programs or program modules can be created using any of the techniques known to one skilled in the art or can be designed in connection with existing software. For example, programs or program modules can be designed in or by means of Java, C++, HTML, XML, or HTML with included Java applets or in SAP R/3 or ABAP. One or more of such modules can be integrated in existing e-mail or browser software.

Moreover, while illustrative embodiments of the invention have been described herein, the scope of the invention includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive.

Accordingly, other embodiments of the invention will be apparent to those skilled in the art from consideration of the specification and practice of the invention disclosed herein. It is therefore intended that the specification and examples be considered as exemplary only, with a true scope and spirit of the invention being indicated by the following claims.

1. A data processing method comprising:
providing a set of database tables;
providing a user interface for entering a combination of at least first and second database tables of the set of database tables;
storing the combination in a combination database table; and
providing an application program for processing of the database tables and the combination database table.

2. The method of claim 1, further comprising:
selecting the first and the second database tables from the set of database tables;
combining entries of the first database table and the second database table to create pairs of entries; and
storing the pairs in the combination database table.

3. The method of claim 1, further comprising:
displaying a matrix having a column direction for displaying entries of the first database table and having a row direction for displaying of entries of the second database table; and
displaying a check-box in the matrix elements for entering combinations of entries of the first and second database tables.

4. The method of claim 1, further comprising:
selecting a number (n) of database tables from the set of database tables;
combining entries of the selected database tables to create n-tuples, each one of the n-tuples containing an entry from each one of the selected database tables; and
storing the n-tuples in the combination database table.

5. The method of claim 4, further comprising:
displaying a first list of entries of the first database table;
displaying a second list of entries of the second database table; and
entering a graphical connector between one of the entries of the first list and one of the entries of the second list to determine a combination of the entries.

6. The method of claim 5, further comprising:
selecting an entry of the first or the second lists; and
displaying the connectors being connected to the selected entry.

7. The method of claim 1, further comprising entering rules for the combination of entries of the at least first and second database tables.

8. A computer program product stored on a digital storage medium, comprising program means for performing the method comprising:
providing a user interface for entering a combination of at least first and second database tables of a set of database tables; and
storing the combination in a combination database table for access of an application program.

9. The computer program product of claim 8, wherein the user interface is enabled to allow the entering of a selection of the first and the second database tables and combining of entries of the first database table and the second database table to create pairs of entities, wherein the program means are adapted to store the pairs in the combination database table.

10. The computer program product of claim 8, the program means being adapted to display a matrix having a column direction for displaying entries of the first database table and having a row direction for displaying entries of the second database table and to display check-boxes in the matrix elements for entering of combinations of entries.

11. The computer program product of claim 8, the user interface being adapted to allow the entering of a selection of a number (n) of database tables of the set of database tables and to combine entries of the selected database tables to create m-tuples, each one of the m-tuples containing one entry from each one of the database tables, and the program means being adapted to store the m-tuples in the combination database table.

12. The computer program product of claim 8, the program means being further adapted for:
displaying a first list of entries of the first database table;
displaying a second list of entries of the second database table; and
entering a graphical connector between one of the entries of the first list and one of the entries of the second list to determine a combination of the entries.

13. The computer program product of claim 12, the program means being further adapted to enable a user to select one of the entries and to display the connectors being connected to the selected entry.

14. A data processing system comprising:
a data warehouse having a set of database tables;
a user interface for entering a combination of at least first and second database tables of the set of database tables;
a combination database table for storing of the combination; and
an application program for processing of the database tables and the combination database table.

15. The data processing system of claim 14, wherein the user interface is adapted to allow entering of a selection of the first and the second database tables and entering of a combination of entries of the first database table and the second database table to create pairs of entries.

16. The data processing system of claim 14, further comprising a display for displaying a matrix having a column direction for displaying of entries of the first database table and having a row direction for displaying of entries of the second database table, and for displaying check-boxes in the matrix elements for entering combinations of entries of the first and second database tables.

17. The data processing system of claim 14, the user interface being adapted to enter a selection of a number (n) of database tables of the set of database tables, and to enter a combination of entries of the selected database tables to create m-tuples, each one of the m-tuples containing one entry from each of the selected database tables.

18. The data processing system of claim 14, further comprising means for displaying the first list of entries in the first database table and for displaying a second list of entries and the second database table, wherein the user interface is adapted for entering of a graphical connector between selected entries of the first and the second lists in order to determine the combination of the entries.

19. The data processing system of claim 14, the user interface being adapted for entering a selection of one of the entries of the first or second lists, and to display connectors being connected to the selected entry.
